(19) United States
(12) Patent Application Publication
(10) Pub. No.: US 2024/0067180 A1
(43) Pub. Date: Feb. 29, 2024

(54) INFORMATION DISTRIBUTION APPARATUS AND NARROW-AREA AUTOMATIC DRIVING SYSTEM

(71) Applicant: Mitsubishi Electric Corporation, Tokyo (JP)

(72) Inventors: Toshihide SATAKE, Tokyo (JP); Keisuke MORITA, Tokyo (JP); Takahisa AOYAGI, Tokyo (JP); Hiroshi YAMADA, Tokyo (JP); Toru HIGUCHI, Tokyo (JP)

(73) Assignee: Mitsubishi Electric Corporation, Tokyo (JP)

(21) Appl. No.: 18/096,362

(22) Filed: Jan. 12, 2023

(30) Foreign Application Priority Data
Aug. 30, 2022 (JP) 2022-136449

(51) Int. Cl. B60W 40/06; B60W 50/08; B60W 60/00; G01C 21/00

(52) U.S. Cl. CPC B60W 40/06; B60W 50/08; B60W 60/001; G01C 21/3815; G01C 21/3885; B60W 2554/4041; B60W 2556/45

(57) ABSTRACT

An information distribution apparatus includes an obstacle identification apparatus that identifies an obstacle to a vehicle traveling in an area and then outputs obstacle information related to the position of the obstacle, a road database representing the positions of roads, and an impassable-road determination means that determines a road through which the vehicle cannot pass, based on the obstacle information outputted from the obstacle identification apparatus and the road database, and then outputs impassable-road information. A narrow-area automatic driving system is provided with the information distribution apparatus and the vehicle that travels from a departure point to a target point, along a route formed based on information outputted from the information distribution apparatus.

### BACKGROUND OF THE INVENTION

### Field of the Invention

The present disclosure relates to an information distribution apparatus and a narrow-area automatic driving system.

### Description of the Related Art

In recent years, there has been a tendency in which in a limited area such as a factory area, a distribution center area, or a mountain area, a vehicle is made to travel through unmanned automatic driving so that transportation capacity for articles and passengers is secured while shortage of drivers is coped with. An unmanned automatic driving system in a limited area such as a factory area, a distribution center area, or a mountain area is referred to as a narrow-area automatic driving system; in a narrow-area automatic driving system, it is required that the state of a traffic road is always and correctly comprehended and that a vehicle driven through automatic driving travels on an appropriate route so as not to collide with an obstacle such as another vehicle, a pedestrian, another object, or the like.

As a conventional technology that always comprehends the state of a traffic road and provides an appropriate traveling route, Patent Document 1 discloses an assistance apparatus that creates a corrected route obtained by correcting a preliminarily determined basic route, based on damage data indicating the degree of damage in a traffic road.

### PRIOR ART REFERENCE

### Patent Document

[Patent Document 1] Japanese Patent No. 6476773

### SUMMARY OF THE INVENTION

Because the conventional technology disclosed in Patent Document 1 is applied not to a traffic situation including two or more vehicles, pedestrians, and other objects at an ordinary time but to damage in a traffic road at a time of disaster or the like, there has been a problem that no narrow-area automatic driving system to be applied to a limited area such as a factory area, a distribution center area, or a mountain area can be realized.

The present disclosure is to disclose a technology for solving the foregoing problem; the objective thereof is to provide an information distribution apparatus that distributes information to be applied not only to damage in a traffic road but also to a traffic situation.

In addition, the present disclosure is to disclose a technology for solving the foregoing problem; the objective thereof is to provide a narrow-area automatic driving system provided with the information distribution apparatus that distributes information to be applied not only to damage in a traffic road but also to a traffic situation.

An information distribution apparatus disclosed in the present disclosure is characterized
in that in an environment where in an area in which among two or more points, a route is formed of a single road or by connecting two or more roads, a vehicle travels along the route, the information distribution apparatus distributes information related at least to the route to the vehicle,
in that there is provided an obstacle identification apparatus that identifies an obstacle to the vehicle and outputs obstacle information related at least to a position of the obstacle, and
in that the obstacle information outputted from the obstacle identification apparatus is distributed to the vehicle in the area.

An information distribution apparatus disclosed in the present disclosure is characterized
in that in an environment where in an area in which among two or more points, a route is formed of a single road or by connecting two or more roads, a vehicle travels along the route, the information distribution apparatus distributes information related at least to the route to the vehicle,
in that there are provided
   an obstacle identification apparatus that identifies an obstacle to the vehicle and outputs obstacle information related at least to a position of the obstacle,
   a road database representing positions of the roads, and
   an impassable-road determination means that determines a road through which the vehicle cannot pass, based on the obstacle information outputted from the obstacle identification apparatus and the road database, and then outputs impassable-road information based on the determination, and
in that the impassable-road information outputted from the impassable-road determination means is distributed to the vehicle in the area.

An information distribution apparatus disclosed in the present disclosure is characterized
in that in an environment where in an area in which among two or more points, a route is formed of a single road or by connecting two or more roads, a vehicle travels along the route, the information distribution apparatus distributes information related at least to the route to the vehicle,
in that there are provided
   an obstacle identification apparatus that identifies an obstacle to the vehicle and outputs obstacle information related at least to a position of the obstacle,
   a road database representing positions of the roads,
   a route database having information related to formation of the route with the roads,
   a point input means that inputs positional information pieces on a departure point from which the vehicle departs and a target point at which the vehicle arrives,
   an impassable-road determination means that determines a road through which the vehicle cannot pass, based on the obstacle information outputted from the obstacle identification apparatus and the road database, and then outputs impassable-road information based on the determination, and
   a route extraction means that extracts a passable route from the departure point to the target point, formed of only roads through which the vehicle can pass, based on the position information pieces inputted by the point input means, the route database, and the impassable-road information outputted from the impassable-road determination means, and
in that information related to the passable route outputted from the route extraction means is distributed to the vehicle in the area.

A narrow-area automatic driving system disclosed in the present disclosure includes an obstacle identification apparatus that identifies an obstacle to a vehicle and outputs obstacle information related at least to a position of the obstacle; the narrow-area automatic driving system is characterized
in that there are provided
   an information distribution apparatus that distributes the obstacle information, outputted from the obstacle identification apparatus, to the vehicle in the area, and
   a vehicle that travels in the area,
in that the vehicle includes
   a road database representing positions of the roads,
   a route database having information related to formation of the route with the roads,
   a point input means that inputs positional information pieces on a departure point from which the vehicle departs and a target point at which the vehicle arrives,
   an impassable-road determination means that determines a road through which the vehicle cannot pass, based on the obstacle information outputted from the obstacle identification apparatus and the road database, and then outputs impassable-road information based on the determination, and
   a route extraction means that extracts a passable route from the departure point to the target point, formed of only roads through which the vehicle can pass, based on the position information pieces inputted by the point input means, the route database, and the impassable-road information outputted from the impassable-road determination means, and
in that the vehicle travels in the area, along the passable route extracted by the route extraction means.

A narrow-area automatic driving system disclosed in the present disclosure includes
an obstacle identification apparatus that identifies an obstacle to the vehicle and outputs obstacle information related at least to a position of the obstacle,
a road database representing positions of the roads, and
an impassable-road determination means that determines a road through which the vehicle cannot pass, based on the obstacle information outputted from the obstacle identification apparatus and the road database, and then outputs impassable-road information based on the determination; the narrow-area automatic driving system is characterized
in that there are provided
   an information distribution apparatus that distributes the impassable-road information, outputted from the impassable-road determination means, to the vehicle in the area, and
   a vehicle that travels in the area,
in that the vehicle includes
   a route database having information related to formation of the route with the roads,
   a point input means that inputs positional information pieces on a departure point from which the vehicle departs and a target point at which the vehicle arrives, and
   a route extraction means that extracts a passable route from the departure point to the target point, formed of only roads through which the vehicle can pass, based on the position information pieces inputted by the point input means, the route database, and the impassable-road information outputted from the impassable-road determination means, and
in that the vehicle travels in the area, along the passable route extracted by the route extraction means.

A narrow-area automatic driving system disclosed in the present disclosure includes an obstacle identification apparatus that identifies an obstacle to a vehicle and outputs obstacle information related at least to a position of the obstacle; the narrow-area automatic driving system is characterized
in that there are provided
   an information distribution apparatus that distributes the obstacle information, outputted from the obstacle identification apparatus, to the vehicle in the area, and
   a vehicle that travels in the area,
in that the vehicle includes
   a road database representing positions of the roads,
   a route database having information related to formation of the route with the roads,
   a point input means that inputs positional information pieces on a departure point from which the vehicle departs and a target point at which the vehicle arrives,
   an impassable-road determination means that determines a road through which the vehicle cannot pass, based on the obstacle information outputted from the obstacle identification apparatus and the road database, and then outputs impassable-road information based on the determination, and
   a route extraction means that extracts a passable route from the departure point to the target point, formed of only roads through which the vehicle can pass, based on the position information pieces inputted by the point input means, the route database, and the impassable-road information outputted from the impassable-road determination means,
in that the impassable-road determination means includes a first impassable-road determination means and a second impassable-road determination means,
in that the first impassable-road determination means determines a road through which the vehicle cannot pass, based on the obstacle information outputted from the obstacle identification apparatus and the road database,
in that through visual confirmation by an operator, the second impassable-road determination means determines a road that has been determined to be impassable by the first impassable-road determination means, and then outputs the impassable-road information, based on a result of the determination,
in that the route extraction means extracts a passable route from the departure point to the target point, formed of only roads through which the vehicle can pass, based on the position information pieces inputted by the point input means, the route database, and the impassable-road information outputted from the second impassable-road determination means, and
in that the vehicle travels in the area, along the passable route extracted by the route extraction means.

A narrow-area automatic driving system disclosed in the present disclosure includes
an obstacle identification apparatus that identifies an obstacle to the vehicle and outputs obstacle information related at least to a position of the obstacle,
a road database representing positions of the roads, and
an impassable-road determination means that determines a road through which the vehicle cannot pass, based on the obstacle information outputted from the obstacle identification apparatus and the road database, and then outputs impassable-road information based on the determination; the narrow-area automatic driving system is characterized
in that there are provided
   an information distribution apparatus that distributes the impassable-road information, outputted from the impassable-road determination means, to the vehicle in the area, and
   a vehicle that travels in the area,
in that the impassable-road determination means provided in the information distribution apparatus includes a first impassable-road determination means and a second impassable-road determination means,
in that the first impassable-road determination means determines a road through which the vehicle cannot pass, based on the obstacle information outputted from the obstacle identification apparatus and the road database,
in that through visual confirmation by an operator, the second impassable-road determination means determines a road that has been determined to be impassable by the first impassable-road determination means, and then outputs the impassable-road information, based on a result of the determination,
in that the vehicle includes
   a route database having information related to formation of the route with the roads,
   a point input means that inputs positional information pieces on a departure point from which the vehicle departs and a target point at which the vehicle arrives, and
   a route extraction means that extracts a passable route from the departure point to the target point, formed of only roads through which the vehicle can pass, based on the position information pieces inputted by the point input means, the route database, and the impassable-road information outputted from the impassable-road determination means,
in that the route extraction means extracts a passable route from the departure point to the target point, formed of only roads through which the vehicle can pass, based on the position information pieces inputted by the point input means, the route database, and the impassable-road information outputted from the second impassable-road determination means, and
in that the vehicle travels in the area, along the passable route extracted by the route extraction means.

The present disclosure makes it possible to obtain an information distribution apparatus that distributes information to be applied not only to damage in a traffic road but also to a traffic situation.

In addition, the present disclosure related to a narrow-area automatic driving system makes it possible to obtain an automatic driving system provided with the information distribution apparatus that distributes information to be applied not only to damage in a traffic road but also to a traffic situation.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a conceptual diagram representing an information distribution apparatus and a narrow-area automatic driving system according to each of Embodiments 1 and 4;

FIG. 2 is a functional block diagram representing the configuration of a control apparatus in the information distribution apparatus according to Embodiment 1;

FIG. 3A is a set of explanatory diagrams for a road database in the information distribution apparatus and the narrow-area automatic driving system according to Embodiment 1;

FIG. 3B is an explanatory chart for road coordinates in the information distribution apparatus and the narrow-area automatic driving system according to Embodiment 1;

FIG. 4A is a set of explanatory tables for a route database in the information distribution apparatus and the narrow-area automatic driving system according to Embodiment 1;

FIG. 4B is an explanatory diagram for the route database in the information distribution apparatus and the narrow-area automatic driving system according to Embodiment 1;

FIG. 5 is a set of explanatory diagrams for obstacle information in the information distribution apparatus and the narrow-area automatic driving system according to Embodiment 1;

FIG. 6 is a flowchart for explaining the respective operation items of the information distribution apparatus and the narrow-area automatic driving system according to Embodiment 1;

FIG. 7 is a conceptual diagram representing an information distribution apparatus and a narrow-area automatic driving system according to each of Embodiments 2 and 5;

FIG. 8 is a conceptual diagram representing an information distribution apparatus and a narrow-area automatic driving system according to each of Embodiments 3 and 6;

FIG. 9 is a functional block diagram representing the configuration of a control apparatus in the information distribution apparatus and the narrow-area automatic driving system according to Embodiment 4;

FIG. 10 is a flowchart for explaining the operation of the control apparatus in the information distribution apparatus and the narrow-area automatic driving system according to Embodiment 4; and

FIG. 11 is a block diagram representing an example of the hardware configuration of a CPU included in the control apparatus or in a constituent element thereof in the information distribution apparatus and the narrow-area automatic driving system according to each of Embodiments 1 through 6.

### DETAILED DESCRIPTION OF THE PREFERRED EMBODIMENTS

The after-mentioned information distribution apparatus and narrow-area automatic driving system according to each of Embodiments 1 through 6 is applied to a narrow-area automatic driving system in a limited area such as a factory area, a distribution center area, or a mountain area. In addition, the narrow-area automatic driving system according to the present disclosure may be either an unmanned automatic driving system in which no operator is on board in a vehicle or a manned automatic driving system in which an operator is on board in a vehicle.

Hereinafter, the information distribution apparatus and the narrow-area automatic driving system according to each of Embodiments will be explained with reference to the drawings; however, each of the drawings will be explained by designating the same or similar constituent members and elements with the same reference numerals.

### Embodiment 1

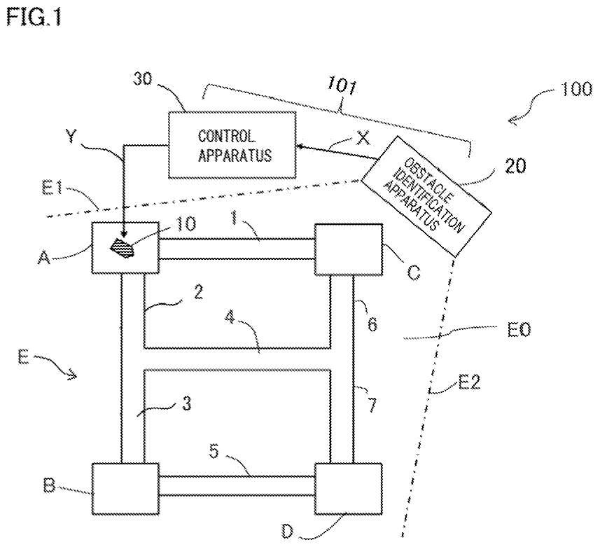

FIG. 1 is a conceptual diagram representing an information distribution apparatus and a narrow-area automatic driving system according to Embodiment 1. In FIG. 1, a narrow-area automatic driving system 100 in which a vehicle 10 is automatically driven, for example, in an area E as a limited area such as a factory area, a distribution center area, or a mountain area has an information distribution apparatus 101 and the vehicle 10 that is automatically driven based on information distributed from the information distribution apparatus 101.

In the area E, there exist two or more points A, B, C, and D that are apart from one another and two or more roads 1, 2, 3, 4, 5, 6, and 7 that are each provided between the respective corresponding two out of the points A, B, C, and D. The vehicle 10 travels along a route formed of any one of the two or more roads 1, 2, 3, 4, 5, 6, and 7 or a route formed by connecting arbitrary two or more roads 1, 2, 3, 4, 5, 6, and 7 so as to move from any one of the two or more points A, B, C, and D to another point.

The information distribution apparatus 101 has an obstacle identification apparatus 20 and a control apparatus 30. The obstacle identification apparatus 20 identifies an obstacle existing in the area E and then outputs the identification result as obstacle information X. In this situation, the obstacles signify the ones including a vehicle, a pedestrian, other objects that each become obstacles at least to the travel of the vehicle 10. The control apparatus 30 outputs route information Y to the vehicle 10, while considering the obstacle information X outputted from the obstacle identification apparatus 20. The route information Y includes an instruction on a route on which the vehicle 10 should travel; the vehicle 10 travels in accordance with the route instruction from the control apparatus 30 so as to move from any one to any other of the points A though D in the area E.

The obstacle identification apparatus 20 is equipped with apparatuses such as a camera, a radar, and a communication apparatus (unillustrated), obtains, in real time, information items such as the respective shapes, positions, and moving speeds of obstacles including a vehicle, a person, and other objects within an identification area E0 surrounded by identification limits E1 and E2 of the obstacle identification apparatus 20, outputs the obtained information items as the obstacle information X, and then transmits the information items to the control apparatus 30 every predetermined period.

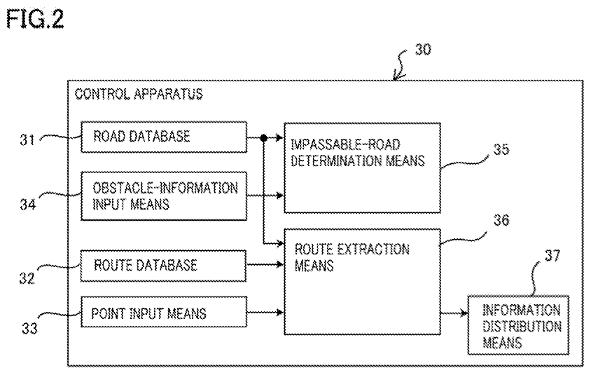

FIG. 2 is a functional block diagram representing the configuration of the control apparatus in the information distribution apparatus according to Embodiment 1. In FIG. 2, the control apparatus 30 has a road database 31, a route database 32, a point input means as a point input device 33, an obstacle-information input means 34, an impassable-road determination means as an impassable-road determiner 35, a route extraction means as a route extraction device 36, and an information distribution means 37.

The control apparatus or a constituent element thereof in the information distribution apparatus and the narrow-area automatic driving system according to each of Embodiment 1 and after-mentioned Embodiments 2 through 6 is configured, for example, with a CPU (Central Processing Unit) or a MPU (Micro processing Unit). In the following explanation, it is assumed that the control apparatus or the constituent element thereof is configured with a CPU.

FIG. 11 is a block diagram representing an example of the hardware configuration of a CPU included in the control apparatus or in the constituent element thereof in the information distribution apparatus and the narrow-area automatic driving system according to each of Embodiments 1 through 6. As represented in FIG. 11, a CPU 112 includes a processor 1001 and a storage apparatus 1002. Although not illustrated, the storage apparatus 1002 has a volatile storage device such as a random access memory and a nonvolatile auxiliary storage device such as a flash memory.

In addition, instead of the flash memory, a hard disk may be included as the auxiliary storage device. The processor 1001 executes a program inputted from the storage apparatus 1002. In this case, the program is inputted from the auxiliary storage device to the processor 1001 by way of the volatile storage device. Moreover, the processor 1001 may output data such as a calculation result either to the volatile storage device of the storage apparatus 1002 or to the auxiliary storage device by way of the volatile storage device.

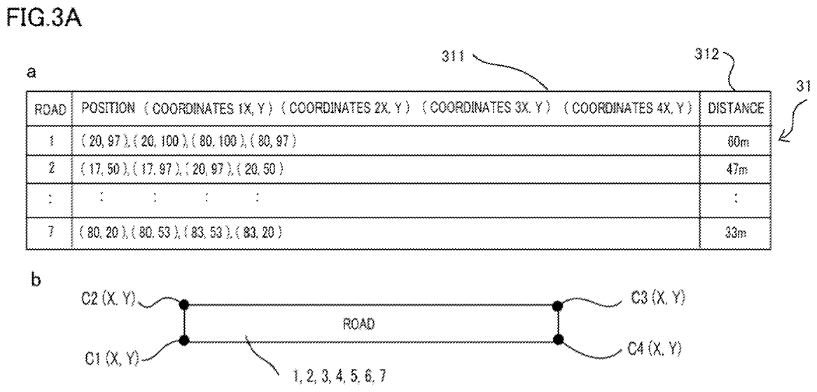

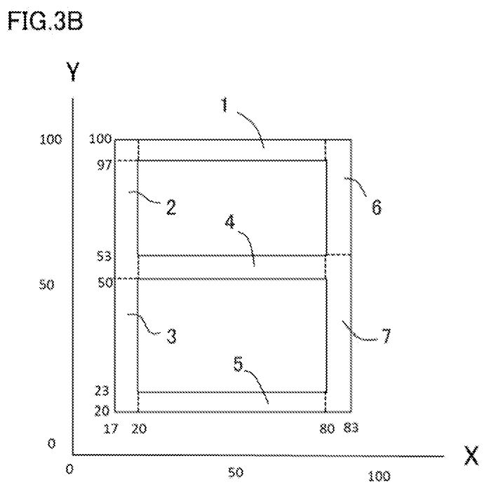

Next, the road database 31 will be explained. FIG. 3A is a set of explanatory diagrams for the road database in the information distribution apparatus and the narrow-area automatic driving system according to Embodiment 1; “a” is a configuration diagram of the road database 31, and “b” is an explanatory diagram representing the configuration of road coordinates.

FIG. 3B is an explanatory chart for the road coordinates in the information distribution apparatus and the narrow-area automatic driving system according to Embodiment 1. In addition, in FIG. 3B, there are omitted the point A existing at a position including the connection portion between the road 1 and the road 2, the point B existing at a position including the connection portion between the road 3 and the road 5, the point C existing at a position including the connection portion between the road 1 and the road 6, and the point D existing at a position including the connection portion between the road 5 and the road 7.

As represented in “a” of FIG. 3A, the road database 31 has coordinate data 311 that indicates the respective positions of the roads 1 through 7 and distance data 312 that indicates the respective distances of the roads 1 through 7. As represented in “b” of FIG. 3A, the coordinate data 311 indicating the respective positions of the roads represents the positions of the four corners of each of the roads 1 through 7 by coordinates C1(X,Y), coordinates C2(X,Y), coordinates C3(X,Y), and coordinates C4(X,Y).

As represented in FIGS. 3A and 3B, the position of the road 1 is expressed by the coordinates C1(20,97), the coordinates C2(20,100), the coordinates C3(80,100), and the coordinates C4(80,97). The position of the road 2 is expressed by the coordinates C1(17,50), the coordinates C2(17,97), the coordinates C3(20,97), and the coordinates C4(20,50). Although the positions of the roads 3 through 6 are not represented in FIG. 3A, the road 3 is expressed by the coordinates C1(17,20), the coordinates C2(17,50), the coordinates C3(20,50), and the coordinates C4(20,20), and the road 4 is expressed by the coordinates C1(20,50), the coordinates C2(20,53), the coordinates C3(80,53), and the coordinates C4(80,50).

Similarly, the road 5 is expressed by the coordinates C1(20,20), the coordinates C2(20,23), the coordinates C3(80,23), and the coordinates C4(80,20). The road 6 is expressed by the coordinates C1(80,53), the coordinates C2(80,100), the coordinates C3(83,100), and the coordinates C4(83,53). As represented in FIG. 3A, the road 7 is expressed by the coordinates C1(80,20), the coordinates C2(80,53), the coordinates C3(83,53), and the coordinates C4(83,20).

In addition, as far as the distances of the roads are concerned, actually measured values of the roads 1 through 7 are recorded; for example, as represented in “a” of FIG. 3A, 60[m], 47[m], . . . , 33[m] are recorded in the road database 31, as the respective distances of the roads 1 through 7.

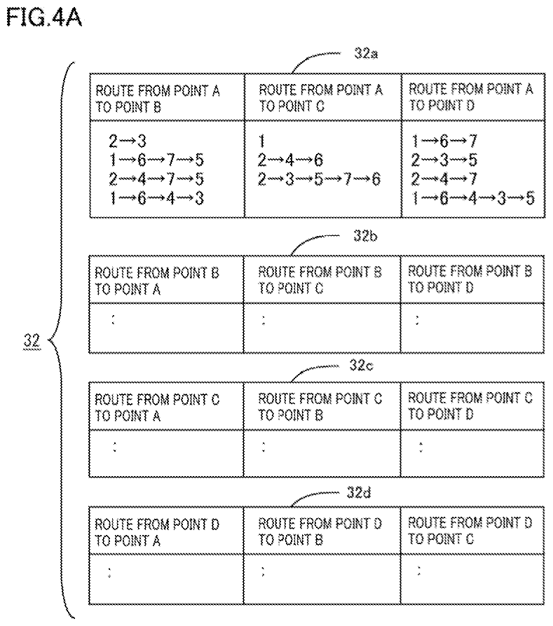

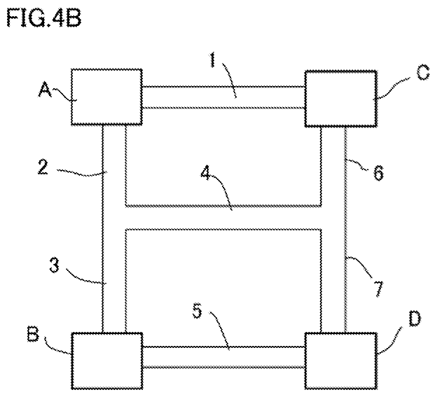

Next, the route database 32 in FIG. 2 will be explained. FIG. 4A is a set of explanatory tables for the route database in the information distribution apparatus and the narrow-area automatic driving system according to Embodiment 1; FIG. 4B is an explanatory diagram for routes in the information distribution apparatus and the narrow-area automatic driving system according to Embodiment 1.

In the case of Embodiment 1, as represented in FIG. 4A, the route database 32 includes
a first route data 32a indicating the respective routes from the point A to the point B, from the point A to the point C, and from the point A to the point D,
a second route data 32b indicating the respective routes from the point B to the point A, from the point B to the point C, and from the point B to the point D,
a third route data 32c indicating the respective routes from the point C to the point A, from the point C to the point B, and from the point C to the point D, and
a fourth route data 32d indicating the respective routes from the point D to the point A, from the point D to the point B, and from the point D to the point C.

In addition, in FIG. 4A, specific route data is described only in the first route data 32a.

Each of the first route data 32a, the second route data 32b, the third route data 32c, and the fourth route data 32d included in the route database 32 indicates the predetermined candidates for the route from the specific point to another point. The candidates for each of the routes include a single road through which a vehicle passes or two or more roads to be connected with one another in the order of passages of the vehicle.

In FIGS. 4A and 4B, for example, in the first route data 32a, as the candidates for the route from the point A to the point B, there are stored
the route in which the vehicle passes through the road 2 and the road 3 in that order,
the route in which the vehicle passes through the road 1, the road 6, the road 7, and the road 5 in that order,
the route in which the vehicle passes through the road 2, the road 4, the road 7, and the road 5 in that order, and
the route in which the vehicle passes through the road 1, the road 6, the road 4, and the road 3 in that order.

Similarly, in the first route data 32a, as the candidates for the route from the point A to the point C, there are stored
the route in which the vehicle passes through the road 1, the route in which the vehicle passes through the road 2, the road 4, and the road 6 in that order, and the route in which the vehicle passes through the road 2, the road 3, the road 5, and the road 7 in that order.

Moreover, in the first route data 32a, as the candidates for the route from the point A to the point D, there are stored
the route in which the vehicle passes through the road 1, the road 6, and the road 7 in that order,
the route in which the vehicle passes through the road 2, the road 3, and the road 5 in that order,
the route in which the vehicle passes through the road 2, the road 4, and the road 7 in that order, and
the route in which the vehicle passes through the road 1, the road 6, the road 4, the road 3, and the road 5 in that order.

In the second route data 32b, there are stored
the candidates for the route from the point B to the point A,
the candidates for the route from the point B to the point C, and
the candidates for the route from the point B to the point D.

In the third route data 32c, there are stored
the candidates for the route from the point C to the point A,
the candidates for the route from the point C to the point B, and
the candidates for the route from the point C to the point D.

In the fourth route data 32d, there are stored
the candidates for the route from the point D to the point A,
the candidates for the route from the point D to the point B, and
the candidates for the route from the point D to the point C.

In addition, the details of the respective route candidates stored in the second route data 32b, the third route data 32c, and the fourth route data 32d can be comprehended, as is the case with the first route data 32a, by referring to, for example, FIG. 4B; therefore, the specific explanations for the foregoing route candidates will be omitted.

In FIG. 2, the point input means 33 is configured in such a way as to input a departure point, which is the present point of a vehicle before departure and a target point, which is the destination of the vehicle. The departure point and the target point are inputted to the point input means 33 through operation by an operator, through a preliminarily prepared program, through communication from a traveling requester, or the like.

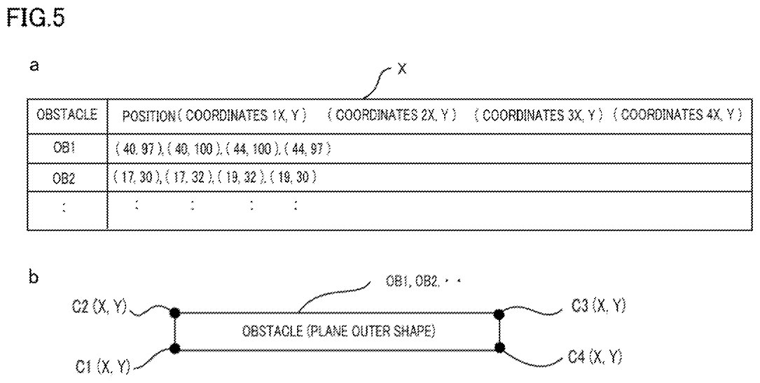

The obstacle information X outputted from the obstacle identification apparatus 20 is inputted to the obstacle-information input means 34. FIG. 5 is a set of explanatory diagrams for obstacle information in the information distribution apparatus and the narrow-area automatic driving system according to Embodiment 1; “a” indicates data of the obstacle information X, and “b” indicates the coordinates of the plane outer shape of an obstacle. The obstacle information X is represented by the four-corner coordinates of the plane outer shape of each of obstacles OB1, OB2, . . . , and the like identified by the obstacle identification apparatus 20. The four-corner coordinates of the plane outer shape of each of the obstacles OB1, OB2, . . . , and the like are the same as the road coordinates represented in foregoing FIG. 3A.

As represented in “a” of FIG. 5, the obstacle information X includes information pieces on the individual obstacles OB1, OB2, . . . (“ . . . ” means obstacles other than OB1 and OB2; the same applies hereinafter) identified by the obstacle identification apparatus 20. Each of the obstacles OB1, OB2, . . . is expressed by the coordinates C1(X,Y), the coordinates C2(X,Y), the coordinates C3(X,Y), and the coordinates C4(X,Y) of the four corners of each of the obstacles OB1, OB2, . . . represented in the “b” of FIG. 5.

For example, the obstacle OB1 is expressed by the coordinates C1(40, 97), the coordinates C2(40,100), the coordinates C3(33, 100), and the coordinates C4(44, 97); it is suggested that the obstacle OB1 exists on the road 1. The obstacle OB2 is expressed by the coordinates C1(17, 30), the coordinates C2(17,32), the coordinates C3(19, 32), and the coordinates C4(19, 30); it is suggested that the obstacle OB2 exists on the road 3.

In FIG. 2, the impassable-road determination means 35 refers to the road database 31 and the obstacle information X from the obstacle-information input means 34 so as to determine which road is an impassable road through which the vehicle cannot pass due to an obstacle OB; then, the impassable-road determination means 35 outputs road data on the impassable road, based on the determination.

Based on data pieces on the departure point and the target point from the point input means 33, the road data from the road database 31, the route data from the route database 32, the road data on the impassable road determined by the impassable-road determination means 35, the route extraction means 36 extracts a route formed of only passible roads for the vehicle 10 between the departure point and the target point and then outputs the extracted route data. The information distribution means 37 transmits the route data on the route extracted by the route extraction means 36, as the route information Y, to the vehicle 10.

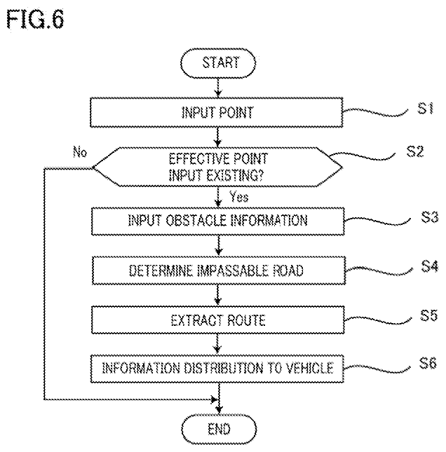

Next, the operation items of the information distribution apparatus and the narrow-area automatic driving system, configured as described above, according to Embodiment 1 will be explained. FIG. 6 is a flowchart for explaining the respective operation items of the information distribution apparatus and the narrow-area automatic driving system according to Embodiment 1. In FIG. 6, at first, in the step S1, the point input means 33 in the control apparatus 30 inputs the departure point and the target point. In this situation, when no traveling request exists, no effective point input exists; thus, the step S1 is followed by the step S2, where it is determined whether or not any effective point input exists.

In the case where it is determined in the step S2 that no effective point input exists (No), the present processing is ended; in the case where any effective point input exists (Yes), the step S2 is followed by the step S3. In the step S3, the obstacle information X is inputted to the control apparatus 30 through the obstacle-information input means 34. The respective positional information pieces on the obstacles OB1, OB2, . . . such as another vehicle, a pedestrian, and an object are inputted in the format represented in FIG. 5. Next, in the step S4, the impassable-road determination means 35 refers to the road database 31 and the obstacle information X so as to determine which road is an impassable road through which the vehicle 10 cannot pass; then, the impassable-road determination means 35 inputs the determination result to the route extraction means 36.

The road positions are stored in the road database 31 in the format represented in FIG. 3. In the step S4, the impassable-road determination means 35 refers to the road positions represented in FIG. 3 and the obstacle position represented in FIG. 5 so as to determines whether or not the road position and the obstacle position overlap each other. That is to say, it is determined whether or not the road quadrangle expressed by the coordinates of the four corners and the obstacle quadrangle expressed by the coordinates of the four corners overlap each other; in the case where the road quadrangle and the obstacle quadrangle overlap each other, the particular road is determined to be an impassable road. This determination is applied to all of the roads 1, 2, 3, 4, 5, 6, and 7 represented in FIG. 3A and to all of the obstacles OB1, OB2, . . . represented in “a” of FIG. 5.

In this situation, in the determination whether or not the road quadrangle expressed by the coordinates of the four corners and the obstacle quadrangle expressed by the coordinates of the four corners overlap each other, it is determined whether or not at least one of the four-corner coordinates of the obstacles OB1, OB2, . . . is included in the quadrangle expressed by the four-corner coordinates of at least one of the roads 1, 2, 3, 4, 5, 6, and 7.

Next, in the step S5, the route extraction means 36 extracts routes formed of only the roads through which the vehicle 10 can pass. Based on the departure point and the target point inputted by the point input means 33, the road database 31, the route database 32, and the impassable roads determined by the impassable-road determination means 35, the route extraction means 36 extracts routes formed of only the roads through which the vehicle 10 can pass.

The route database 32 is configured in the format represented in FIG. 4 and indicates respective predetermined candidates for the routes from the departure point to the target point. The route extraction means 36 removes the routes including the impassable roads from two or more candidates for the route corresponding to the departure point and the target point and then extracts the route, among the remaining route candidates, that has the shortest total distance. In addition, the total route distance can be calculated by adding the respective distances of the roads, represented in the road database 31, for each of the routes.

In the case where there exist two or more routes, the total route distance of each of which is the shortest, the route extraction means 36 extracts any one of the two or more routes, based on a predetermined method, for example, the route having the higher-priority order (e.g., in the order of description in “a” of FIG. 4A) in each of the first route data 32a, the second route data 32b, the third route data 32c, and the fourth route data 32d included in the route database 32.

At last, in the step S6, the information distribution means 37 transmits the route extracted by the route extraction means 36, as the route information Y, to the vehicle 10; then, the present processing by the control apparatus 30 is ended.

The vehicle 10, which has received the route information Y from the control apparatus 30, travels through automatic driving in the area E, in accordance with the route information Y. In other words, the vehicle 10 travels to move in the order of the roads included in the route from the departure point to the target point.

As described above, in the information distribution apparatus and the narrow-area automatic driving system according to Embodiment 1, information for determining whether or not a road is passable is obtained; an impassable road is determined; then, a passable route is determined and is transmitted to a vehicle; as a result, the vehicle can travel without hindrance on the passable route from the departure point to the target point. Because an impassable road is determined based on the positions of obstacles such as another vehicle, a pedestrian, and an object and the positions of roads, there can be realized a narrow-area automatic driving system to be applied also to a limited area such as a factory area, a distribution center area, or a mountain area.

In addition, in Embodiment 1, when an impassable road is determined, only identification information from the obstacle identification apparatus, i.e., “dynamic information” defined by a so-called dynamic map is utilized; however, when an impassable road is determined by adopting also “quasi-static information” such as information of impassability caused by construction and by considering information items on the time zone and the impassable position, the vehicle can more securely travel.

Moreover, in Embodiment 1, there has been described an example in which each of an obstacle and a road is expressed by four-corner coordinate values; however, the coordinate values are not limited to four-corner coordinate values; it may be allowed that each of the obstacle and the road is expressed by the coordinate values the number of which corresponds to the shape thereof. Furthermore, it may be allowed that an obstacle is expressed by the coordinates of the center thereof and the vertical and horizontal widths and that a road is expressed by the coordinates of the center thereof, the road length, the road width, and the like.

Moreover, in Embodiment 1, there has been described an example in which before a vehicle departs, the route for the target point is selected and is distributed to the vehicle; however, it may be allowed that even after the vehicle has started to travel, impassable-road determination is performed every predetermined time and that when the scheduled traveling road becomes impassable, an updated route is distributed to the vehicle.

Furthermore, it may be allowed that a means for notification from a vehicle to a control apparatus is provided and that when a sensor mounted in the vehicle detects an obstacle or when due to another cause, the vehicle encounters a situation where the vehicle cannot travel on a road, the vehicle requests the control apparatus to update the route and distribute the updated route again.

Still moreover, in Embodiment 1, there is selected a route, among passable routes, that has the shortest total distance; however, the present invention is not limited thereto; for example, it may be allowed that the respective times required for passing roads are stored in the road database and there is selected a route whose total traveling time is shortest.

### Embodiment 2

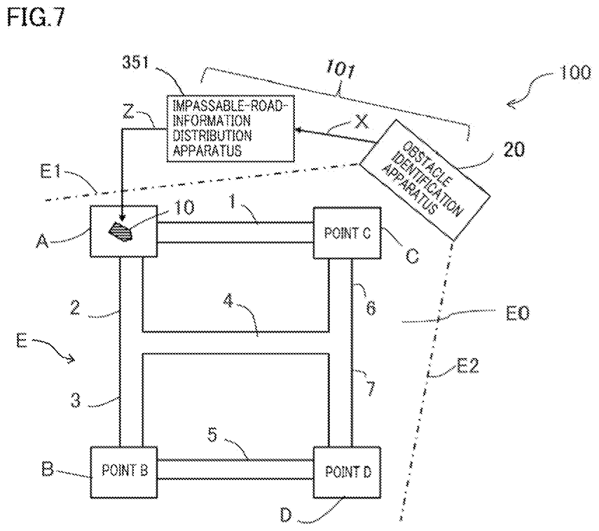

FIG. 7 is a conceptual diagram representing an information distribution apparatus and a narrow-area automatic driving system according to each of Embodiments 2 and 5. Embodiment. J will De described later. In FIG. 7, the narrow-area automatic driving system 100 has an information distribution apparatus 101 and the vehicle 10 that is automatically driven based on information distributed from the information distribution apparatus 101.

The information distribution apparatus 101 has the obstacle identification apparatus 20 and an impassable-road-information distribution apparatus 351. The obstacle identification apparatus 20 identifies an obstacle existing in the area E and then outputs the identification result as obstacle information X. In this situation, the obstacles signify the ones including a vehicle, a pedestrian, other objects that each become obstacles at least to the travel of the vehicle 10.

The impassable-road-information distribution apparatus 351 has the road database 31 represented in FIG. 3A of foregoing Embodiment 1, the obstacle-information input means 34 represented in FIG. 2 of Embodiment 1, and the impassable-road determination means 35 represented in FIG. 2 of Embodiment 1. In the impassable-road-information distribution apparatus 351, based on the obstacle information X inputted from the obstacle identification apparatus 20 to the obstacle-information input means 34 and the road database 31, the impassable-road determination means 35 determines an impassable road, and then distributes impassable-road information Z to the vehicle 10.

The vehicle 10 has the following constituent elements; in the case of Embodiment 1, the constituent elements are provided in the control apparatus 30. That is to say, the vehicle 10 has the route database 32 that is represented in FIG. 4A and has information related to formation of a route with roads, the point input means 33 that inputs respective positional information pieces on the departure point and the target point of the vehicle 10, and the route extraction means 36.

Based on the impassable-road information Z outputted from the impassable-road determination means 35 in the information distribution apparatus 101, the route database 32, and the departure point and the target point inputted by the point input means 33, the route extraction means 36 extracts a passable route formed of only the roads through which the vehicle 10 can pass. The vehicle 10 travels in the foregoing area, based on the passable route extracted by the route extraction means 36.

In addition, the respective operation items of the information distribution apparatus and the narrow-area automatic driving system according to Embodiment 2 are substantially the same as those in the flowchart in FIG. 6 of Embodiment 1; thus, the explanations therefor will be omitted.

### Embodiment 3

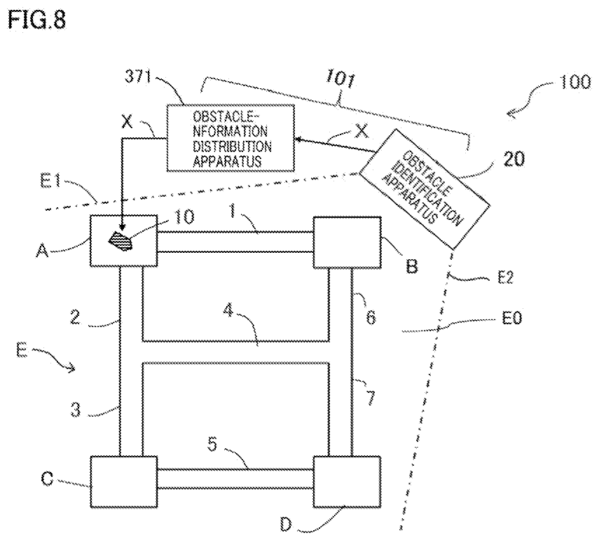

FIG. 8 is a conceptual diagram representing an information distribution apparatus and a narrow-area automatic driving system according to each of Embodiments 3 and 6. Embodiment 6 will be described later. In FIG. 8, the narrow-area automatic driving system 100 has an information distribution apparatus 101 and the vehicle 10 that is automatically driven based on information distributed from the information distribution apparatus 101.

The information distribution apparatus 101 has the obstacle identification apparatus 20 and an obstacle-information distribution apparatus 371. The obstacle identification apparatus 20 identifies an obstacle existing in the area E and then outputs the identification result as obstacle information X. In this situation, the obstacles signify the ones including a vehicle, a pedestrian, other objects that each become obstacles at least to the travel of the vehicle 10. The obstacle-information distribution apparatus 371 distributes the obstacle information X inputted from the obstacle identification apparatus 20 to the vehicle 10.

The vehicle 10 has the following constituent elements; in the case of Embodiment 1, the constituent elements are provided in the control apparatus 30. That is to say, the vehicle 10 has the road database 31 that is represented in FIG. 3A of foregoing Embodiment 1 and indicates road positions, the route database 32 that is represented in FIG. 4A and has information related to formation of a route with a single road or two or more roads, the point input means 33 that inputs respective positional information pieces on the departure point and the target point of the vehicle 10, the impassable-road determination means 35, the obstacle-information input means 34, and the route extraction means 36.

Based on the obstacle information X outputted from the obstacle identification apparatus 20 and the road database 31, the impassable-road determination means 35 determines a road through which the vehicle 10 cannot pass, and then outputs impassable-road information Z based on the determination.

Based on the position information inputted by the point input means, the route database 32, and the impassable-road information outputted from the impassable-road determination means 35, the route extraction means 36 extracts a passable route from the departure point to the target point, formed of only the roads through which the vehicle 10 can pass. The vehicle 10 travels in the foregoing area, based on the passable route extracted by the route extraction means 36.

In addition, the respective operation items of the information distribution apparatus and the narrow-area automatic driving system according to Embodiment 3 are substantially the same as those in the flowchart in FIG. 6 of Embodiment 1; thus, the explanations therefor will be omitted.

### Embodiment 4

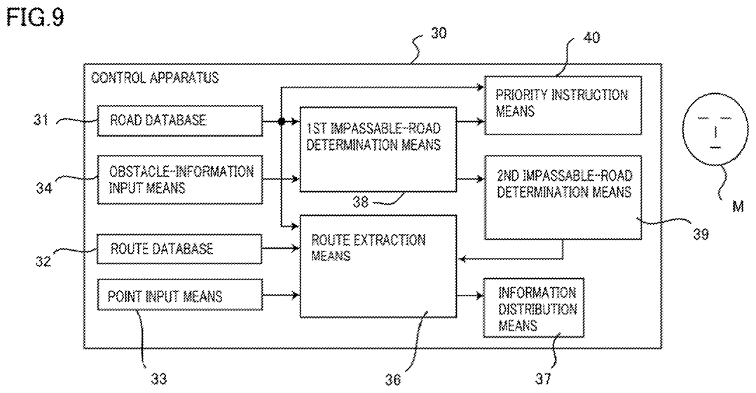

FIG. 1 is a conceptual diagram representing the information distribution apparatus and the narrow-area automatic driving system according to each of foregoing Embodiment 1 and Embodiment 4. FIG. 9 is a functional block diagram representing the configuration of a control apparatus in the information distribution apparatus and a narrow-area automatic driving system according to Embodiment 4. The conceptual diagram representing the information distribution apparatus and the narrow-area automatic driving system according to Embodiment 4 is the same as that in Embodiment 1. Embodiment 4 differs from Embodiment 1 in the configuration of the inside of the control apparatus.

FIG. 9 is a functional block diagram representing the configuration of the control apparatus in the information distribution apparatus and the narrow-area automatic driving system according to Embodiment 4. In FIG. 9, the road database 31, the route database 32, the point input means 33, and the obstacle-information input means 34 are the same as those in Embodiment 1. In addition, as is the case with the impassable-road determination means 35 in Embodiment 1, a first impassable-road determination means 38 determines an impassable road; then, the first impassable-road determination means 38 outputs the result to a second impassable-road determination means 39 and a priority instruction means as a priority instruction device 40.

An operator M applies visual confirmation to a road that has been determined to be impassable by the first impassable-road determination means 38; the second impassable-road determination means 39 outputs the road determined to be impassable in the visual confirmation to the route extraction means 36. The priority instruction means 40 instructs the operator M on the priority with which the visual confirmation should be performed; in Embodiment 4, based on the output of the first impassable-road determination means 38 and the road database 31, the priority instruction means 40 determines the priority and then instructs the operator M on the priority.

In addition, the visual confirmation by the operator can be performed through a well-known method; an image of a camera set in the area E is visually confirmed or the visual confirmation is performed on the spot, and then the result is inputted through a tablet terminal or the like.

Based on the departure point and the target point, the road database 31, the route database 32, and the impassable roads determined by the second impassable-road determination means 39, the route extraction means 36 extracts routes from the departure point to the target point, formed of only the roads through which the vehicle 10 can pass. The information distribution means 37 is the same as that in Embodiment 1.

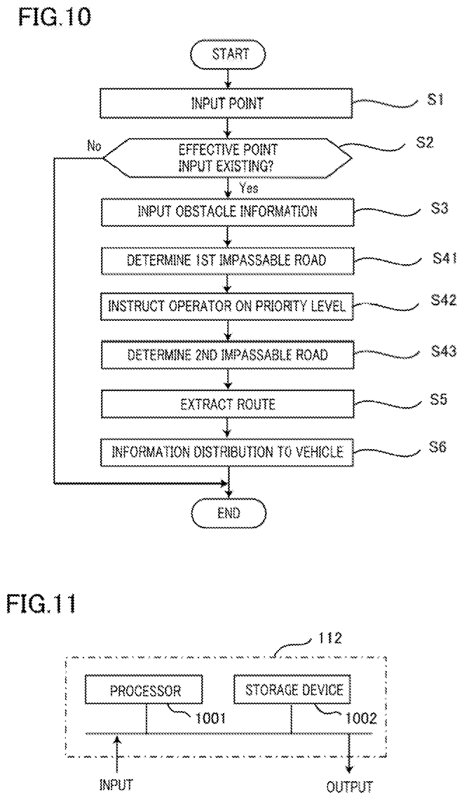

Next, the operation of the information distribution apparatus and the narrow-area automatic driving system according to Embodiment 4 will be explained. FIG. 10 is a flowchart for explaining the operation of the control apparatus in the information distribution apparatus and the narrow-area automatic driving system according to Embodiment 4. In FIG. 10, the operation from the steps S1 through S3 is the same as the operation from the steps S1 through S3 in the flowchart represented in FIG. 6 of Embodiment 1.

In Embodiment 4, in the step S41 following the step S3, the first impassable-road determination means 38 determines an impassable road, which is a road that cannot be passed. This processing corresponds to the step S4 in Embodiment 1.

Next, in the step S42, the priority instruction means 40 instructs the operator M on the priority levels of the roads to be visually confirmed by the operator M. In this situation, the priority instruction means 40 gives instruction in such a way that in accordance with the road distances indicated in the road database 31, the operator can confirm the roads, determined to be impassable by the first impassable-road determination means 38, in descendent order of the road length.

The operator M visually confirms the roads in accordance with the priority levels instructed by the priority instruction means 40. The operator M visually determines whether or not the road that has been determined to be impassable by the first impassable-road determination means 38 is really impassable; then, in the step S43, the operator M inputs the result to the second impassable-road determination means 39.

Next, in the step S5, as is the case with Embodiment 1, the route extraction means 36 extracts the route formed of only the passable roads; in the step S6, the information distribution means 37 transmits the extracted route, as the route information Y, to the vehicle 10; then, the present processing by the control apparatus 30 is ended.

The vehicle 10 that has received the route information Y travels in the area, in accordance with the route information Y. That is to say, the vehicle 10 moves from the departure point to the target point, in the order of the roads.

As described above, the information distribution apparatus and the narrow-area automatic driving system according to Embodiment 4 are configured in such away as to determine the state of a road through visual confirmation by an operator in addition to the method in Embodiment 1. Moreover, in the determination, without hesitation, the operator can visually confirm roads in the appropriate order, so that it is made possible to realize a narrow-area automatic driving system that can more stably operate.

In addition, in Embodiment 4, based on the determination result from the second impassable-road determination means 39, the route extraction means 36 extracts the route formed of only the passable roads; however, for example, in the case where the determination by the second impassable-road determination means 39 takes a long time, at first, based on the determination result from the first impassable-road determination means, the route extraction means 36 extracts a route and the control apparatus 30 distributes the route information Y to the vehicle; after that, based on the determination result from the second impassable-road determination means 39, the route extraction means 36 extracts the route again and the control apparatus 30 distributes the route information Y to the vehicle; as a result, the vehicle can be prevented from being made to wait until the second impassable-road determination ends.

Moreover, in Embodiment 4, there has been described an example in which the operator M are visually confirms the roads that have been determined to be impassable by the first impassable-road determination means 38, in descending order of the road length; however, the present invention is not limited thereto; it may be allowed to determine the priority by various effective indexes. For example, it may be allowed that there is prioritized the road existing at an important point in terms of the route configuration, i.e., when the road is impassable, the total route distance conspicuously extends; alternatively, it may be allowed that the information pieces from the obstacle-information input means 34 each include obstacle-detection reliability indexes and that there is prioritized a road that is impassable due to an obstacle having a low detection reliability.

### Embodiment 5

FIG. 7 is a conceptual diagram representing the information distribution apparatus and the narrow-area automatic driving system according to Embodiment 2 or an information distribution apparatus and a narrow-area automatic driving system according to Embodiment 5; FIG. 7 is a conceptual diagram applied to both Embodiment 5 and foregoing Embodiment 2. In FIG. 7, the narrow-area automatic driving system 100 has an information distribution apparatus 101 and the vehicle 10 that is automatically driven based on information distributed from the information distribution apparatus 101.

The information distribution apparatus 101 has the obstacle identification apparatus 20 and an impassable-road-information distribution apparatus 351. The obstacle identification apparatus 20 identifies an obstacle existing in the area E and then outputs the identification result as obstacle information X. In this situation, the obstacles signify the ones including a vehicle, a pedestrian, other objects that each become obstacles at least to the travel of the vehicle 10.

The impassable-road-information distribution apparatus 351 includes
the road database 31 represented in FIG. 3A of foregoing Embodiment 1,
the first impassable-road determination means 38 represented in FIG. 9 of foregoing Embodiment 4,
the second impassable-road determination means 39 represented in FIG. 9 of foregoing Embodiment 4, and
the priority instruction means 40 represented in FIG. 9 of foregoing Embodiment 4.

The vehicle 10 has the following constituent elements; in the case of Embodiment 4, the constituent elements are provided in the control apparatus 30. That is to say, the vehicle 10 has the route database 32 that is represented in FIG. 4A and has information related to formation of a route with roads, the point input means 33 that inputs respective positional information pieces on the departure point and the target point of the vehicle 10, the route database 32, and the route extraction means 36.

Based on the impassable-road information Z outputted from the impassable-road determination means 351 in the information distribution apparatus 101, the route database 32, and the departure point and the target point inputted by the point input means 33, the route extraction means 36 extracts a passable route formed of only the roads through which the vehicle 10 can pass. The vehicle 10 travels in the foregoing area, based on the passable route extracted by the route extraction means 36.

In addition, the respective operation items of the information distribution apparatus and the narrow-area automatic driving system according to Embodiment 5 are substantially the same as those in the flowchart in FIG. 10 of Embodiment 4; thus, the explanations therefor will be omitted.

### Embodiment 6

FIG. 8 is a conceptual diagram representing the information distribution apparatus and the narrow-area automatic driving system according to Embodiment 3 or an information distribution apparatus and a narrow-area automatic driving system according to Embodiment 6; FIG. 8 is a conceptual diagram applied to both Embodiment 6 and foregoing Embodiment 3. In FIG. 8, the narrow-area automatic driving system 100 has an information distribution apparatus 101 and the vehicle 10 that is automatically driven based on information distributed from the information distribution apparatus 101.

The information distribution apparatus 101 has the obstacle identification apparatus 20 and an obstacle-information distribution apparatus 371. The obstacle identification apparatus 20 identifies an obstacle existing in the area E and then outputs the identification result as obstacle information X. In this situation, the obstacles signify the ones including a vehicle, a pedestrian, other objects that each become obstacles at least to the travel of the vehicle 10. The obstacle-information distribution apparatus 371 distributes the obstacle information X inputted from the obstacle identification apparatus 20 to the vehicle 10.

The vehicle 10 has the following constituent elements; in the case of Embodiment 4, the constituent elements are provided in the control apparatus 30. That is to say, the vehicle 10 has the road database 31 that is represented in FIG. 3A of foregoing Embodiment 1 and indicates road positions, the route database 32 that is represented in FIG. 4A and has information related to formation of a route with a single road or two or more roads, the point input means 33 that inputs respective positional information pieces on the departure point and the target point of the vehicle 10, the first impassable-road determination means 38, the second impassable-road determination means 39, the priority instruction means 40, and the route extraction means 36.

Based on the impassable-road information Z outputted from the second impassable-road determination means 39 in the information distribution apparatus 101, the route database 32, and the departure point and the target point inputted by the point input means 33, the route extraction means 36 extracts a passable route formed of only the roads through which the vehicle 10 can pass. The vehicle 10 travels in the foregoing area, based on the passable route extracted by the route extraction means 36.

In addition, the respective operation items of the information distribution apparatus and the narrow-area automatic driving system according to Embodiment 6 are substantially the same as those in the flowchart in FIG. 10 of Embodiment 4; thus, the explanations therefor will be omitted.

Although the present disclosure is described above in terms of various exemplary embodiments, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present application. For example, at least one of the constituent components may be modified, added, or eliminated. At least one of the constituent components mentioned in at least one of the preferred embodiments may be selected and combined with the constituent components mentioned in another preferred embodiment.

Next, the respective features of the information distribution apparatuses and the narrow-area automatic driving systems disclosed in the present disclosure will be described as appendixes.

(Appendix 1) An information distribution apparatus,
wherein in an environment where in an area in which among two or more points, a route is formed of a single road or by connecting two or more roads, a vehicle travels along the route, the information distribution apparatus distributes information related at least to the route to the vehicle,
wherein there is provided an obstacle identification apparatus that identifies an obstacle to the vehicle and outputs obstacle information related at least to a position of the obstacle, and
wherein the obstacle information outputted from the obstacle identification apparatus is distributed to the vehicle in the area.
   (Appendix 2) An information distribution apparatus,
wherein in an environment where in an area in which among two or more points, a route is formed of a single road or by connecting two or more roads, a vehicle travels along the route, the information distribution apparatus distributes information related at least to the route to the vehicle,
wherein there are provided
   an obstacle identification apparatus that identifies an obstacle to the vehicle and outputs obstacle information related at least to a position of the obstacle,
   a road database representing positions of the roads,
   an impassable-road determination means that determines a road through which the vehicle cannot pass, based on the obstacle information outputted from the obstacle identification apparatus and the road database, and then outputs impassable-road information based on the determination, and
wherein the impassable-road information outputted from the impassable-road determination means is distributed to the vehicle in the area.
   (Appendix 3) An information distribution apparatus,
wherein in an environment where in an area in which among two or more points, a route is formed of a single road or by connecting two or more roads, a vehicle travels along the route, the information distribution apparatus distributes information related at least to the route to the vehicle,
wherein there are provided
   an obstacle identification apparatus that identifies an obstacle to the vehicle and outputs obstacle information related at least to a position of the obstacle,
   a road database representing positions of the roads,
   a route database having information related to formation of the route with the roads,
   a point input means that inputs positional information pieces on a departure point from which the vehicle departs and a target point at which the vehicle arrives,
   an impassable-road determination means that determines a road through which the vehicle cannot pass, based on the obstacle information outputted from the obstacle identification apparatus and the road database, and then outputs impassable-road information based on the determination, and
   a route extraction means that extracts a passable route from the departure point to the target point, formed of only roads through which the vehicle can pass, based on the position information pieces inputted by the point input means, the route database, and the impassable-road information outputted from the impassable-road determination means,
wherein information related to the passable route outputted from the route extraction means is distributed to the vehicle in the area.
   (Appendix 4) The information distribution apparatus according to (Appendix 3),
wherein the impassable-road determination means includes a first impassable-road determination means and a second impassable-road determination means,
wherein the first impassable-road determination means determines a road through which the vehicle cannot pass, based on the obstacle information outputted from the obstacle identification apparatus and the road database,
wherein through visual confirmation by an operator, the second impassable-road determination means determines a road that has been determined to be impassable by the first impassable-road determination means, and then outputs the impassable-road information, based on a result of the determination, and
wherein the route extraction means extracts a passable route from the departure point to the target point, formed of only roads through which the vehicle can pass, based on the position information pieces inputted by the point input means, the route database, and the impassable-road information outputted from the second impassable-road determination means.
   (Appendix 5) The information distribution apparatus according to (Appendix 4), further comprising a priority instruction means that instructs the operator on a priority level of a road to which the visual confirmation should be applied and through which the vehicle cannot pass.
   (Appendix 6) The information distribution apparatus according to (Appendix 5), wherein the priority instruction means determines the priority level, based on at least one of a configurational importance of the route and the obstacle information.
   (Appendix 7) The information distribution apparatus according to any one of (Appendix 1) through (Appendix 6), wherein the obstacle information outputted from the obstacle identification apparatus includes impassable-point information indicating a position through which the vehicle cannot pass.
   (Appendix 8) A narrow-area automatic driving system comprising:
the information distribution apparatus according to claim 1; and
a vehicle that travels in the area,
wherein the vehicle includes
   a road database representing positions of the roads,
   a route database having information related to formation of the route with the roads,
   a point input means that inputs positional information pieces on a departure point from which the vehicle departs and a target point at which the vehicle arrives,
   an impassable-road determination means that determines a road through which the vehicle cannot pass, based on the obstacle information outputted from the obstacle identification apparatus and the road database, and then outputs impassable-road information based on the determination, and
   a route extraction means that extracts a passable route from the departure point to the target point, formed of only roads through which the vehicle can pass, based on the position information pieces inputted by the point input means, the route database, and the impassable-road information outputted from the impassable-road determination means,
wherein the vehicle travels in the area, along the passable route extracted by the route extraction means.
   (Appendix 9) A narrow-area automatic driving system comprising:
the information distribution apparatus according to claim 2; and
a vehicle that travels in the area,
wherein the vehicle includes
   a route database having information related to formation of the route with the roads,
   a point input means that inputs positional information pieces on a departure point from which the vehicle departs and a target point at which the vehicle arrives,
   an impassable-road determination means that determines a road through which the vehicle cannot pass, based on the obstacle information outputted from the obstacle identification apparatus and the road database, and then outputs impassable-road information based on the determination, and
   a route extraction means that extracts a passable route from the departure point to the target point, formed of only roads through which the vehicle can pass, based on the position information pieces inputted by the point input means, the route database, and the impassable-road information outputted from the impassable-road determination means,
wherein the vehicle travels in the area, along the passable route extracted by the route extraction means.
   (Appendix 10) A narrow-area automatic driving system comprising:
the information distribution apparatus according to (Appendix 1); and
a vehicle that travels in the area,
wherein the vehicle includes
   a road database representing positions of the roads,
   a route database having information related to formation of the route with the roads,
   a point input means that inputs positional information pieces on a departure point from which the vehicle departs and a target point at which the vehicle arrives,
   an impassable-road determination means that determines a road through which the vehicle cannot pass, based on the obstacle information outputted from the obstacle identification apparatus and the road database, and then outputs impassable-road information based on the determination, and
   a route extraction means that extracts a passable route from the departure point to the target point, formed of only roads through which the vehicle can pass, based on the position information pieces inputted by the point input means, the route database, and the impassable-road information outputted from the impassable-road determination means,
wherein the impassable-road determination means includes a first impassable-road determination means and a second impassable-road determination means,
wherein the first impassable-road determination means determines a road through which the vehicle cannot pass, based on the obstacle information outputted from the obstacle identification apparatus and the road database,
wherein through visual confirmation by an operator, the second impassable-road determination means determines a road that has been determined to be impassable by the first impassable-road determination means, and then outputs the impassable-road information, based on a result of the determination,
wherein the route extraction means extracts a passable route from the departure point to the target point, formed of only roads through which the vehicle can pass, based on the position information pieces inputted by the point input means, the route database, and the impassable-road information outputted from the second impassable-road determination means, and
wherein the vehicle travels in the area, along the passable route extracted by the route extraction means.
   (Appendix 11) A narrow-area automatic driving system comprising:
the information distribution apparatus according to (Appendix 2); and
a vehicle that travels in the area,
wherein the impassable-road determination means provided in the information distribution apparatus includes a first impassable-road determination means and a second impassable-road determination means,
wherein the first impassable-road determination means determines a road through which the vehicle cannot pass, based on the obstacle information outputted from the obstacle identification apparatus and the road database,
wherein through visual confirmation by an operator, the second impassable-road determination means determines a road that has been determined to be impassable by the first impassable-road determination means, and then outputs the impassable-road information, based on a result of the determination,
wherein the vehicle includes
   a route database having information related to formation of the route with the roads,
   a point input means that inputs positional information pieces on a departure point from which the vehicle departs and a target point at which the vehicle arrives, and
   a route extraction means that extracts a passable route from the departure point to the target point, formed of only roads through which the vehicle can pass, based on the position information pieces inputted by the point input means, the route database, and the impassable-road information outputted from the impassable-road determination means,
wherein the route extraction means extracts a passable route from the departure point to the target point, formed of only roads through which the vehicle can pass, based on the position information pieces inputted by the point input means, the route database, and the impassable-road information outputted from the second impassable-road determination means, and
wherein the vehicle travels in the area, along the passable route extracted by the route extraction means.

What is claimed is:

1. An information distribution apparatus,
wherein in an environment where in an area in which among two or more points, a route is formed of a single road or by connecting two or more roads, a vehicle travels along the route, the information distribution apparatus distributes information related at least to the route to the vehicle,
wherein there is provided an obstacle identification apparatus that identifies an obstacle to the vehicle and outputs obstacle information related at least to a position of the obstacle, and
wherein the obstacle information outputted from the obstacle identification apparatus is distributed to the vehicle in the area.

2. The information distribution apparatus according to claim 1, wherein the obstacle information outputted from the obstacle identification apparatus includes impassable-point information indicating a position through which the vehicle cannot pass.

3. An information distribution apparatus,
wherein in an environment where in an area in which among two or more points, a route is formed of a single road or by connecting two or more roads, a vehicle travels along the route, the information distribution apparatus distributes information related at least to the route to the vehicle,
wherein there are provided
an obstacle identification apparatus that identifies an obstacle to the vehicle and outputs obstacle information related at least to a position of the obstacle,
a road database representing positions of the roads, and
an impassable-road determiner that determines a road through which the vehicle cannot pass, based on the obstacle information outputted from the obstacle identification apparatus and the road database, and then outputs impassable-road information based on the determination, and
wherein the impassable-road information outputted from the impassable-road determiner is distributed to the vehicle in the area.

4. The information distribution apparatus according to claim 3, wherein the obstacle information outputted from the obstacle identification apparatus includes impassable-point information indicating a position through which the vehicle cannot pass.

5. An information distribution apparatus,
wherein in an environment where in an area in which among two or more points, a route is formed of a single road or by connecting two or more roads, a vehicle travels along the route, the information distribution apparatus distributes information related at least to the route to the vehicle,
wherein there are provided
an obstacle identification apparatus that identifies an obstacle to the vehicle and outputs obstacle information related at least to a position of the obstacle,
a road database representing positions of the roads, and
a route database having information related to formation of the route with the roads,
a point input device that inputs positional information pieces on a departure point from which the vehicle departs and a target point at which the vehicle arrives,
an impassable-road determiner that determines a road through which the vehicle 10 cannot pass, based on the obstacle information outputted from the obstacle identification apparatus and the road database, and then outputs impassable-road information based on the determination, and
a route extraction device that extracts a passable route from the departure point to the target point, formed of only roads through which the vehicle can pass, based on the position information pieces inputted by the point input device, the route database, and the impassable-road information outputted from the impassable-road determiner, and
wherein information related to the passable route outputted from the route extraction device is distributed to the vehicle in the area.

6. The information distribution apparatus according to claim 5, wherein the obstacle information outputted from the obstacle identification apparatus includes impassable-point information indicating a position through which the vehicle cannot pass.

7. The information distribution apparatus according to claim 5,
wherein the impassable-road determiner includes a first impassable-road determiner and a second impassable-road determiner,
wherein the first impassable-road determiner determines a road through which the vehicle cannot pass, based on the obstacle information outputted from the obstacle identification apparatus and the road database,
wherein through visual confirmation by an operator, the second impassable-road determiner determines a road that has been determined to be impassable by the first impassable-road determiner, and then outputs the impassable-road information, based on a result of the determination, and
wherein the route extraction device extracts a passable route from the departure point to the target point, formed of only roads through which the vehicle can pass, based on the position information pieces inputted by the point input device, the route database, and the impassable-road information outputted from the second impassable-road determiner.

8. The information distribution apparatus according to claim 7, wherein the obstacle information outputted from the obstacle identification apparatus includes impassable-point information indicating a position through which the vehicle cannot pass.

9. The information distribution apparatus according to claim 7, further comprising a priority instruction device that instructs the operator on a priority level of a road to which the visual confirmation should be applied and through which the vehicle cannot pass.

10. The information distribution apparatus according to claim 9, wherein the obstacle information outputted from the obstacle identification apparatus includes impassable-point information indicating a position through which the vehicle cannot pass.

11. The information distribution apparatus according to claim 9, wherein the priority instruction device determines the priority level, based on at least one of a configurational importance of the route and the obstacle information.

12. The information distribution apparatus according to claim 11, wherein the obstacle information outputted from the obstacle identification apparatus includes impassable-point information indicating a position through which the vehicle cannot pass.

13. A narrow-area automatic driving system comprising:
the information distribution apparatus according to claim 1; and
a vehicle that travels in the area,
wherein the vehicle includes
a road database representing positions of the roads,
a route database having information related to formation of the route with the roads,
a point input device that inputs positional information pieces on a departure point from which the vehicle departs and a target point at which the vehicle arrives,
an impassable-road determiner that determines a road through which the vehicle cannot pass, based on the obstacle information outputted from the obstacle identification apparatus and the road database, and then outputs impassable-road information based on the determination, and
a route extraction device that extracts a passable route from the departure point to the target point, formed of only roads through which the vehicle can pass, based on the position information pieces inputted by the point input device, the route database, and the impassable-road information outputted from the impassable-road determiner, and
wherein the vehicle travels in the area, along the passable route extracted by the route extraction device.

14. A narrow-area automatic driving system comprising:
the information distribution apparatus according to claim 3; and
a vehicle that travels in the area,
wherein the vehicle includes
a route database having information related to formation of the route with the roads,
a point input device that inputs positional information pieces on a departure point from which the vehicle departs and a target point at which the vehicle arrives,
an impassable-road determiner that determines a road through which the vehicle cannot pass, based on the obstacle information outputted from the obstacle identification apparatus and the road database, and then outputs impassable-road information based on the determination, and
a route extraction device that extracts a passable route from the departure point to the target point, formed of only roads through which the vehicle can pass, based on the position information pieces inputted by the point input device, the route database, and the impassable-road information outputted from the impassable-road determiner, and
wherein the vehicle travels in the area, along the passable route extracted by the route extraction device.

15. A narrow-area automatic driving system comprising:
the information distribution apparatus according to claim 1; and
a vehicle that travels in the area,
wherein the vehicle includes
a road database representing positions of the roads,
a route database having information related to formation of the route with the roads,
a point input device that inputs positional information pieces on a departure point from which the vehicle departs and a target point at which the vehicle arrives,
an impassable-road determiner that determines a road through which the vehicle cannot pass, based on the obstacle information outputted from the obstacle identification apparatus and the road database, and then outputs impassable-road information based on the determination, and
a route extraction device that extracts a passable route from the departure point to the target point, formed of only roads through which the vehicle can pass, based on the position information pieces inputted by the point input device, the route database, and the impassable-road information outputted from the impassable-road determiner,
wherein the impassable-road determiner includes a first impassable-road determiner and a second impassable-road determiner,
wherein the first impassable-road determiner determines a road through which the vehicle cannot pass, based on the obstacle information outputted from the obstacle identification apparatus and the road database,
wherein through visual confirmation by an operator, the second impassable-road determiner determines a road that has been determined to be impassable by the first impassable-road determiner, and then outputs the impassable-road information, based on a result of the determination,
wherein the route extraction device extracts a passable route from the departure point to the target point, formed of only roads through which the vehicle can pass, based on the position information pieces inputted by the point input device, the route database, and the impassable-road information outputted from the second impassable-road determiner, and
wherein the vehicle travels in the area, along the passable route extracted by the route extraction device.

16. A narrow-area automatic driving system comprising:
the information distribution apparatus according to claim 3; and
a vehicle that travels in the area,
wherein the impassable-road determiner provided in the information distribution apparatus includes a first impassable-road determiner and a second impassable-road determiner,
wherein the first impassable-road determiner determines a road through which the vehicle cannot pass, based on the obstacle information outputted from the obstacle identification apparatus and the road database,
wherein through visual confirmation by an operator, the second impassable-road determiner determines a road that has been determined to be impassable by the first impassable-road determiner, and then outputs the impassable-road information, based on a result of the determination,
wherein the vehicle includes
a route database having information related to formation of the route with the roads,
a point input device that inputs positional information pieces on a departure point from which the vehicle departs and a target point at which the vehicle arrives, and
a route extraction device that extracts a passable route from the departure point to the target point, formed of only roads through which the vehicle can pass, based on the position information pieces inputted by the point input device, the route database, and the impassable-road information outputted from the impassable-road determiner,
wherein the route extraction device extracts a passable route from the departure point to the target point, formed of only roads through which the vehicle can pass, based on the position information pieces inputted by the point input device, the route database, and the impassable-road information outputted from the second impassable-road determiner, and
wherein the vehicle travels in the area, along the passable route extracted by the route extraction device.
